(19) United States
(12) Patent Application Publication
(10) Pub. No.: US 2002/0125323 A1
(43) Pub. Date: Sep. 12, 2002

(54) Optical scanner data collection network employing multi-packet transmission of decoded data

(75) Inventors: David H. Marrs JR., Syracuse, NY (US); Robert M. Hussey, Camillus, NY (US); Joseph Walczyk, Syracuse, NY (US); David M. Holzhauer, Camillus, NY (US); Matthew Pankow, Camillus, NY (US); Todd Dueker, Camillus, NY (US); Thomas Ruhlman, Skaneateles, NY (US); John Pettinelli, Rome, NY (US)

Correspondence Address: Daniel P. Malley, WALL MARJAMA & BILINSKI, 101 South Salina Street, Suite 400, Syracuse, NY, 13202, US

(73) Assignee: Welch Allyn Data Collection, Inc.

(21) Appl. No.: 09/799,967

(22) Filed: Mar. 6, 2001

(51) Int. Cl. G06K 7/10; G06K 9/22

(52) U.S. Cl. 235/462.45

(57) ABSTRACT

A data collection network featuring a plurality of cordless optical scanners communicating to a base terminal is disclosed. The cordless optical scanners are used for reading 2D optically encoded symbols. The optical scanner converts the 2D optically encoded symbol into decoded data. The optical scanner has a packet assembly component that converts the decoded data into packets. A communications component transmits the packets to the base terminal. The decoded data is packetized to accommodate 2D data codes such as PDF417, microPDF, Code One, DataMatrix, MaxiCode, or other 2D symbols. All of these symbols have maximum data capacities exceeding 1,000 bytes of information per symbol. Thus, the data collection network of the present invention provides users with the data transmission capacity required to use high-density data optical bar code symbols in an untethered working environment.

### BACKGROUND OF THE INVENTION

1. Field of the Invention

The present invention relates generally to data collection networks, and particularly to data collection networks that employ optical scanners as data input terminals.

2. Technical Background

Data collection networks that use optical bar code scanners as input terminals are being employed in an ever-expanding variety of work environments. Examples of such network applications include retail, shipping, work-in-progress tracking, inventory control, manufacturing, route accounting, and health care. The sophistication of the networks and bar code scanners have grown markedly to keep pace with this demand.

One area of sophistication relates to wireless networks. The demand for cordless optical scanners operating in a wireless environment is increasing. Many of the new optical scanner applications require freedom of movement. The presence of an electrical cord tethering the optical scanner to a base terminal can be very problematic. In manufacturing or industrial applications, the cord may become entangled in assembly lines or in other machinery having moving parts.

The cordless optical scanners currently on the market have the capability to read optical symbols having limited data capacity. The scanner reads the symbol and refers to a look-up table in memory to retrieve the information corresponding to the symbol. 2D optical codes have been developed to carry large amounts of information, obviating the need for scanners to perform code conversions using look-up tables. Portable data file optical codes, for example, have maximum data capacities exceeding 1,000 bytes of information. PDF 417 can accommodate 2710 digits of information. Code One has a maximum data capacity of 1478 bytes. DataMatrix and MaxiCode symbols have similar data capacities. Unfortunately, currently available cordless optical scanners, and the data collection networks employing them, do not have the data transmission capabilities required to accommodate these large data codes.

Thus, there is a need for an optical scanner data collection network that can accommodate 2D data codes containing large amounts of information. A data collection network is needed to provide users with the data capacity required to perform increasingly complex tasks in an untethered working environment.

### SUMMARY OF THE INVENTION

The existing problems of conventional optical scanners and data collection networks are addressed by the present invention. The present invention relates to multi-packet transmission of decoded data using RF scanners. The present invention also provides a data collection network that can accommodate 2D data codes containing large amounts of information. The data collection network of the present invention provides users with the data transmission capacity required to perform increasingly complex tasks in an untethered working environment.

One aspect of the present invention is a cordless optical scanner for reading a 2D optically encoded symbol. The optical scanner converts the 2D optically encoded symbol into decoded data. The optical scanner includes a packet assembly component operative to convert the decoded data into a plurality of packets. A communications component is coupled to the packet assembly component. The communications component is operative to transmit the plurality of packets to a base terminal.

In another aspect, the present invention includes a data collection network having at least one cordless optical scanner. The optical scanner is operative to convert a 2D optical symbol into a plurality of data packets for transmission over an RF channel. A base terminal is coupled to the at least one cordless optical scanner via the RF channel. The base terminal is operative to reassemble the plurality of packets into decoded data.

In another aspect, the present invention includes a method for transmitting information contained in a 2D optical symbol using a wireless network. The wireless network includes at least one cordless optical scanner and a base terminal. The method includes reading the 2D optical symbol with the cordless optical scanner to thereby generate decoded data. The decoded data is assembled into a plurality of packets. At least one packet of the plurality of packets includes at least 200 bytes of decoded data. The plurality of packets are transferred from the cordless optical scanner to the base terminal over an RF channel. The received plurality of packets are converted into the decoded data.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a perspective view of the optical scanner data collection network according to the present invention;

FIG. 2 is a block diagram of the optical scanner according to the present invention;

FIG. 3 is a diagram representing the memory map of the optical scanner according to the present invention;

FIG. 4A is a diagrammatic depiction of a data packet used to transmit decoded data from an optical scanner to a base terminal when only one data packet is required;

FIG. 4B is a diagrammatic depiction of a header packet and a data packet used to transmit decoded data from an optical scanner to a base terminal when more than one data packet is required;

FIG. 5 is an exemplary optical scanner flow chart according to the present invention;

FIG. 6 is a block diagram of the base terminal according to the present invention;

FIG. 7 is a diagram representing the memory map of base terminal 40 according to the present invention;

FIG. 8 is a diagram showing the structure of a scanner-application look-up table disposed in the memory of the base terminal;

FIG. 9 is a chart showing the structure of an application-parameter look-up table disposed in the memory of the base terminal; and

FIG. 10 is an exemplary base terminal flow chart according to the present invention.

### DETAILED DESCRIPTION OF THE INVENTION

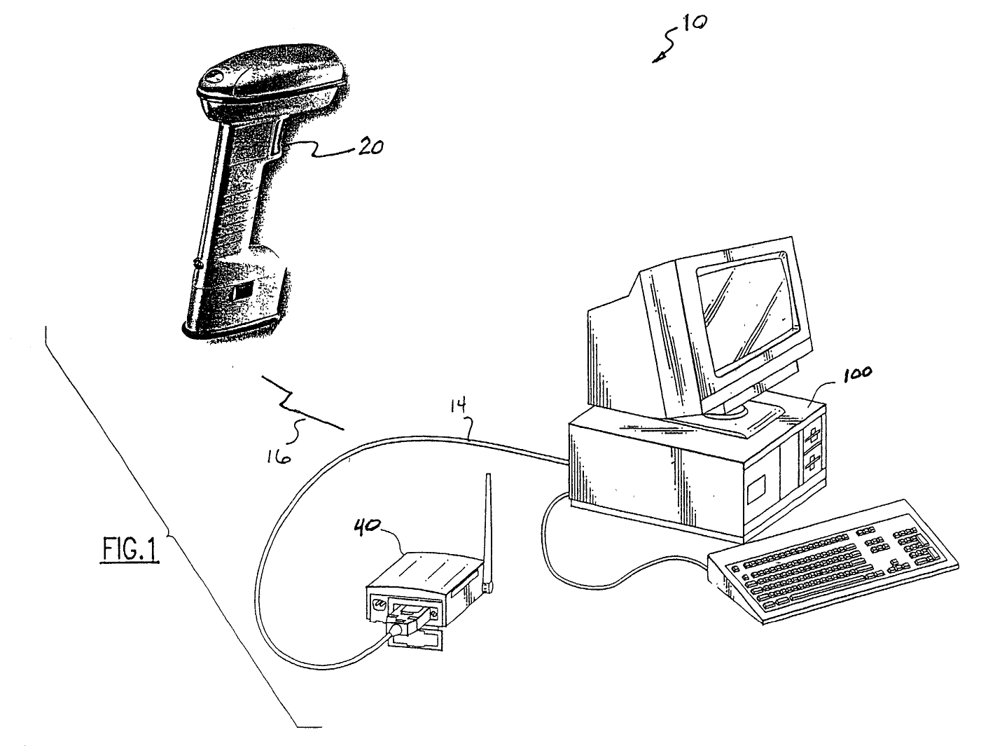

Reference will now be made in detail to the present preferred embodiments of the invention, examples of which are illustrated in the accompanying drawings. Wherever possible, the same reference numbers will be used throughout the drawings to refer to the same or like parts. An exemplary embodiment of the data collection network of the present invention is shown in FIG. 1, and is designated generally throughout by reference numeral 10.

In accordance with the invention, the present invention for a data collection network includes a cordless optical scanner 20 for reading a 2D optically encoded symbol. The optical scanner converts the 2D optically encoded symbol into decoded data. The optical scanner includes a packet assembly component operative to convert the decoded data into a plurality of packets. A communications component transmits the packets to a base terminal. The present invention provides a data collection network that accommodates 2D data codes containing large amounts of data. The data collection network of the present invention provides users with the data transmission capacity required to perform increasingly complex data collection tasks in an untethered working environment.

As embodied herein, and depicted in FIG. 1, a perspective view of the optical scanner data collection network 10 according to the present invention is shown. Data collection network includes N-cordless optical scanners 20 coupled to base terminal 40 by means of radio link 16. Base terminal 40 is connected to host computer 100 by communications link 14. As shown, the optical scanner is a portable self-contained hand-held unit that is capable of scanning and decoding optically encoded symbols. Typically the host computer 100 is provided by the user to further process data collected by base terminal 40.

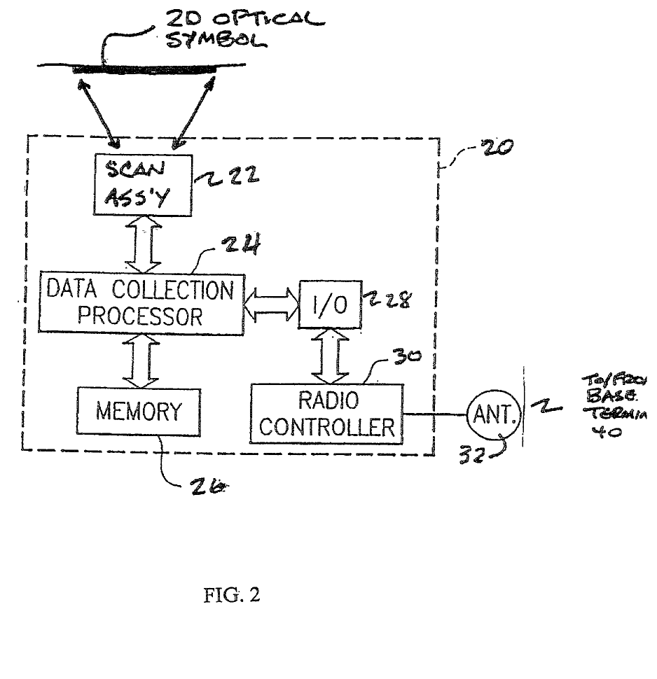

As embodied herein and depicted in FIG. 2, a block diagram of the optical scanner 20 according to the present invention is shown. Cordless scanner 20 includes scan assembly 22, which is connected to processor 24. Processor 24 is connected to memory 26 and I/O port 28. I/O port 28 is connected to radio controller 30. Radio controller 30 is likewise connected to antenna 32.

Scan assembly 22 includes a light source and optics to illuminate the optical symbol. Reflected light returning from the optical symbol is captured by a photodetector element and converted into analog electrical signals representative of the optical symbol. Scan assembly 22 also includes signal processing electronics that digitize the analog signals. It will be apparent to those of ordinary skill in the pertinent art that modifications and variations can be made to scan assembly 22 of the present invention depending on cost and component selection. For example, scan assembly 22 may be image sensor based or laser based. Further, scan assembly 22 may be a linear scanner or an area scanner. A linear scanner captures one row of the 2D symbol at a time, whereas an area scanner captures an image of the entire 2D symbol with one scan.

It will be apparent to those of ordinary skill in the pertinent art that processor 24 may be of any suitable type, but by way of example, processor 24 includes an 8-bit microcomputer having an address space 64K bytes. Processor 24 uses the firmware stored in memory 26 to perform the various tasks necessary to operate scanner 20. Processor 24 may also include an ASIC device to manage and optimize scan assembly 22 operations. The firmware resident in the memory 26 includes decoding component and a packet assembly component. The structure of memory 26 will be discussed below.

The communications component of optical scanner 20 includes radio controller 30. It will be apparent to those of ordinary skill in the pertinent art that radio controller 30 may be of any suitable type, but by way of example, radio controller 30 is adapted to provide frequency hopping spread spectrum communications (FHSS) between scanner 20 and base terminal 40. FHSS is a form of spread spectrum radio transmission that produces a narrow band signal that hops among a plurality of frequencies in a prearranged pattern. FHSS is often used in commercial environments because of its ability to minimize errors due to interference or jamming. However, those of ordinary skill in the art will recognize that optical scanners 20 and base terminal 40 may communicate using other wireless schemes and other modulation formats based on user requirements and environmental factors.

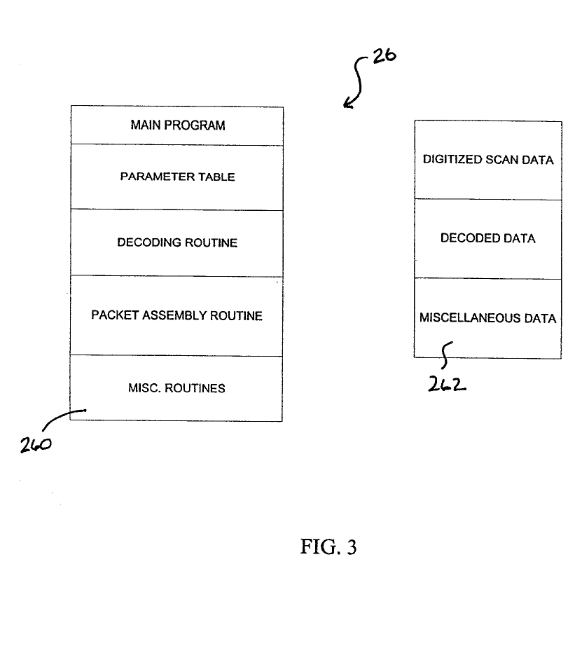

As embodied herein and depicted in FIG. 3, a diagram representing the memory map of the optical scanner according to the present invention is shown. Memory 26 includes read only memory 260 for storing optical scanner firmware. Memory 260 may be of any suitable type, but there is shown by way of example a 32K Byte erasable programmable read only memory (EPROM) 260. Memory 260 includes a main program, a parameter table, decoding routine, packet assembly routine, and other miscellaneous routines that run on processor 24. Memory 26 also includes data storage memory 262. Memory 262 may be of any suitable type, but there is shown by way of example 8K Bytes SRAM which is used by processor 24 for data storage. One portion of memory is used to store digitized scan data. Another portion is used to store the decoded data.

Referring back to memory 260, the parameter table specifies the values of the parameters defining the mode in which the reader will operate. Examples of these parameters include the size and the frame rate of the scan assembly image sensor, the codes that will be enabled during autodiscrimination, communication protocols, beeper pitch and volume. As will be discussed more fully below, the subset of parameter values populating the scanner parameter table are chosen in accordance with the selected application. A complete set of application parameters are stored in base terminal 40 memory. Base terminal 40 uploads the subset of parameter values to scanner 20.

The decoding routine is also stored in firmware. It uses parameters stored in the parameter table. Thus, the decoding routine can be modified by these parameters to decode any number of 2D optical symbols such as PDF 417, microPDF, Code One, DataMatrix or MaxiCode. The present invention also applies to stacked linear symbols and matrix symbols. This list is not all-inclusive. Any type of symbol can be used in conjunction with network 10.

By way of example, the decoding routine for PDF417 symbols will be discussed. The firmware operates on a PDF417 symbol according to a two step process. The first step of the process is row decoding. This step includes locating sequences of PDF417 symbol characters adjoining a stop or start character. This process is complicated by a phenomenon known as scan-stitching wherein the scan path slides from row to row generating invalid characters. The decoding process takes advantage of the fact that all characters start with a space-to-bar transition that is aligned across rows.

The second step of the decoding process is array decoding. In array decoding, the decoded PDF417 characters are placed into appropriate positions in a row and column matrix. These rows are then considered as one concatenated string which is error checked and corrected to generate the decoded data message.

Subsequently, the decoded data message is assembled into one or more packets, depending on the length of the data embedded in the decoded symbol. This step is performed by the packet assembly routine. In one embodiment of the present invention, each packet can accommodate approximately 200 bytes of decoded data in a 256 byte packet. This is merely a representative example, and one of ordinary skill in the art will recognize that the scope of the present invention should not be limited to data packets of a certain size or format.

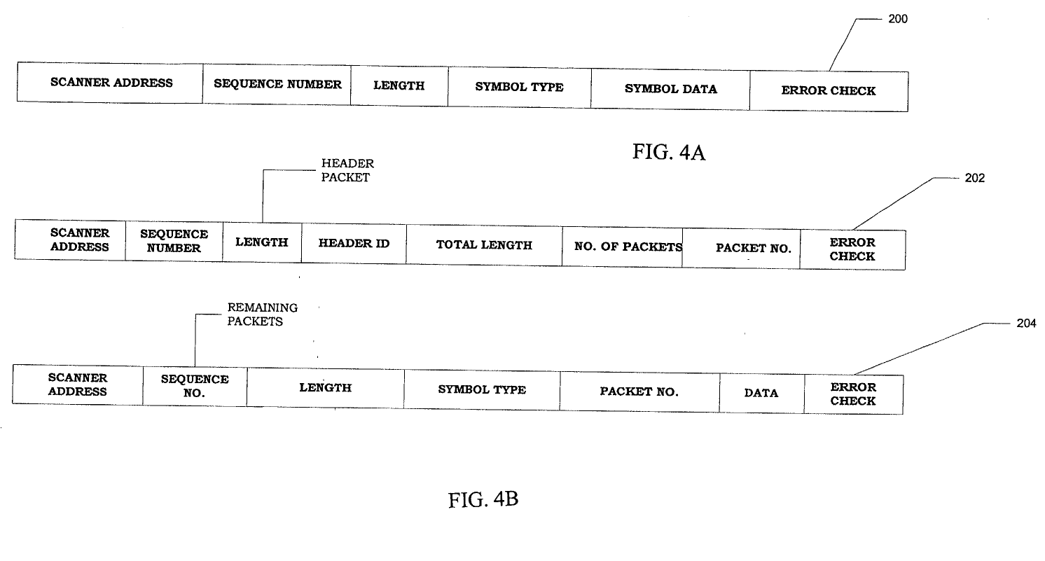

FIG. 4A is a diagrammatic depiction of a data packet used to transmit decoded data from an optical scanner to a base terminal when only one data packet is required. A one packet message employs packet 200 which includes a scanner address field, sequence number field, a packet length field, a symbol type field, symbol data, and an error check field. The scanner address is a scanner identifier. Each scanner 20 numbers each packet with a sequence number, which is includes in the second field. The next field contains the length of the data field. After this, the packet contains a field identifying the type of symbol that was decoded. After the symbol type, the symbol data payload of the packet is inserted. Finally, packet 200 includes error checking bytes.

FIG. 4B is a diagrammatic depiction of a header packet and a data packet used to transmit decoded data from an optical scanner to a base terminal when more than one data packet is required. When more than one packet is required, scanner 20 first transmits header packet 202. After base 40 acknowledges that it can process the remaining packets, scanner 20 transmits the remaining packets 204, which have the format of packet 204. If base 40 cannot process the remaining packets 204, or if there is another problem, base 40 will transmit an application packet to scanner 20 indicating the error. The definitions of the scanner address field, the sequence number field, symbol type, length, symbol data, and error check field were described above, and hence, will not be repeated. Header packet 202 also includes a header identification field, which identifies the packet as a header packet. In the next field, packet 202 includes a total length field, which includes the total length of the data contained in the decoded symbol. The next field includes the total number of packets in the message. The second-last field is the packet number. In the header packet, this number is designated as packet number “one.” The remaining packets 204 also include a packet number field, which are incremented from 2 to N, depending on the total number of packets being transmitted in the message.

One of ordinary skill in the art will recognize that packet 200, packet 202, and packet 204 may be of any suitable type, the diagrammatic depictions in FIG. 4A and FIG. 4B are one embodiment of the present invention. The headers and field type can be implemented in a variety of ways.

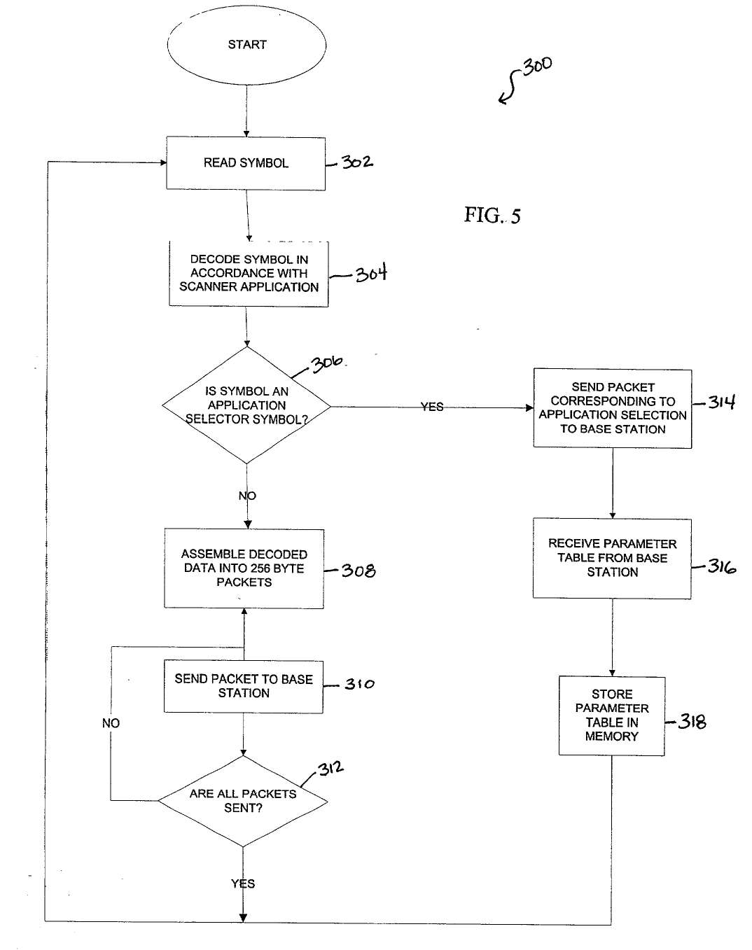

As embodied herein and depicted in FIG. 5, an exemplary optical scanner flow chart 300 according to the present invention is disclosed. In step 302 the optical symbol is read. As discussed above, the image is captured and stored in memory 262 as digitized scan data. The digitized scan data is decoded in step 304, in accordance with the application being run on scanner 20. A PDF417 decoding process was discussed above. It will be apparent to those of ordinary skill in the pertinent art that microPDF, Code One, DataMatrix, MaxiCode or any other 2D symbol can also be decoded when practicing the present invention. After the symbol is decoded, processor 24 determines whether the symbol is an application selector symbol. Application selector symbols are used to reprogram scanner 20. If the symbol is an application selector symbol, a single packet containing the application selection information is sent to base terminal 40 in step 314. In step 316, base terminal 40 retrieves the corresponding parameter table subset and uploads it into scanner 20. In step 318, scanner 20 stores the new parameter table information in memory 260 or 262. Scanner 20 is equipped with a reprogramming routine in firmware which causes scanner 20 to operate in accordance with the new up-loaded parameter table values.

If the decoded symbol is not an application selector symbol, the scanner proceeds to block 308. The concatenated decoded data string is broken into decoded data payloads of approximately 200 bytes each. Of course, the last decoded data payload may only have a few bytes of data, depending on the message size. Block 308 generates headers 202 for each of the packets in the message. Subsequently, a payload is appended to its corresponding header. In block 310, each packet is sent to radio controller 30 via I/O port 28. Radio controller 30 transmits each packet to base terminal 40 until the entire message has been transmitted, in accordance with block 312.

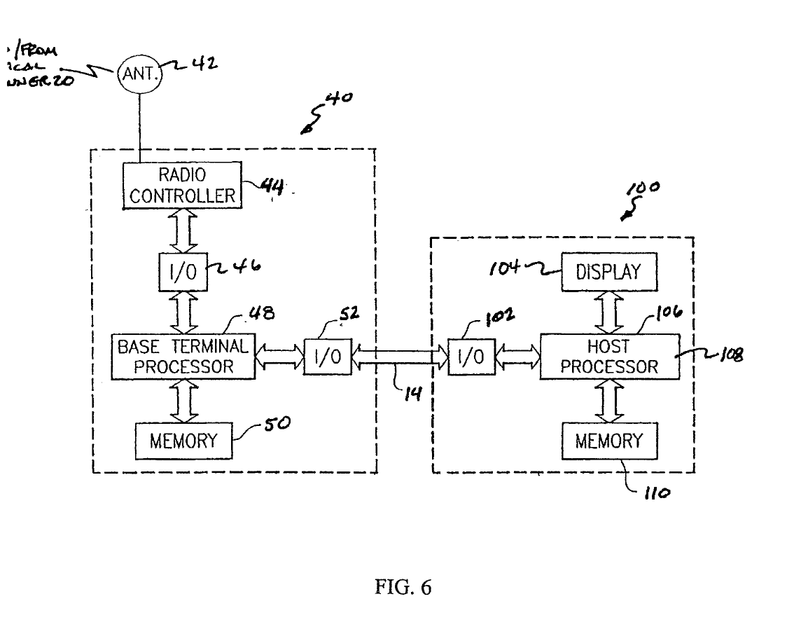

As embodied herein and depicted in FIG. 6, a block diagram of base terminal 40 according to the present invention is depicted. Base terminal 40 transmits and receives messages from optical scanners 20 via antenna 42. Antenna 42 is connected to radio controller 44. Radio controller 44 is coupled to base terminal 48 via I/O port 46. Base terminal processor 48 is also connected to base terminal memory 50. Base terminal 40 also includes a second I/O port 52 that links processor 48 with host 100 via communications link 14.

As discussed above in conjunction with radio controller 30 of optical scanner 20, it will be apparent to those of ordinary skill in the pertinent art that radio controller 44 may be of any suitable type, but by way of example, radio controller 44 is adapted to provide frequency hopping spread spectrum communications (FHSS) between scanner 20 and base terminal 40. Again, those of ordinary skill in the art will recognize that optical scanners 20 and base terminal 40 may communicate using other wireless schemes and other modulation formats based on user requirements and environmental factors.

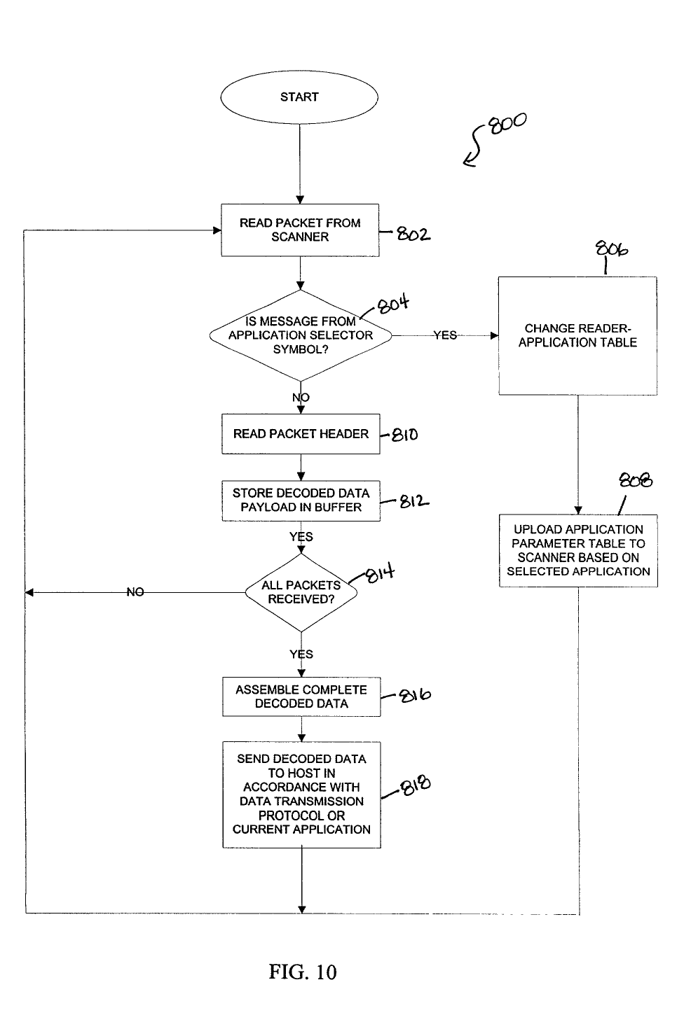

Base terminal processor 48 may be of any suitable type adapted to facilitate contemporaneous execution of a plurality of applications. Each scanner 20 in network 10 may operate according to any number of applications. Each application may specify different data collection protocols, e.g., one scanner may be programmed to decode PDF417 whereas another may be programmed to decoded Code One symbols and read at different data rates. Thus, base 40 is adapted to interface with a plurality of scanners 20 transmitting a plurality of packets. The packets received from scanners 20 are interlaced and appropriately sorted by base 40. The operation of base terminal 40 will be discussed below in conjunction with FIG. 10.

As any skilled artisan will recognize, communications link 100 may be of any suitable type, but by way of example, base terminal 40 may be hard wired to host 100 via an RS-232 communications link. Link 14 may also be implemented using a “wedge” terminal disposed between base terminal 40 and host 100. In other embodiments, link 14 may be implemented using a LAN, or a universal serial bus.

Host computer 100 may include at least one high level data processing software program such as a graphical display program, a spreadsheet program, or word processing program for arranging, displaying and/or organizing the decoded data in accordance with the user's needs and requirements.

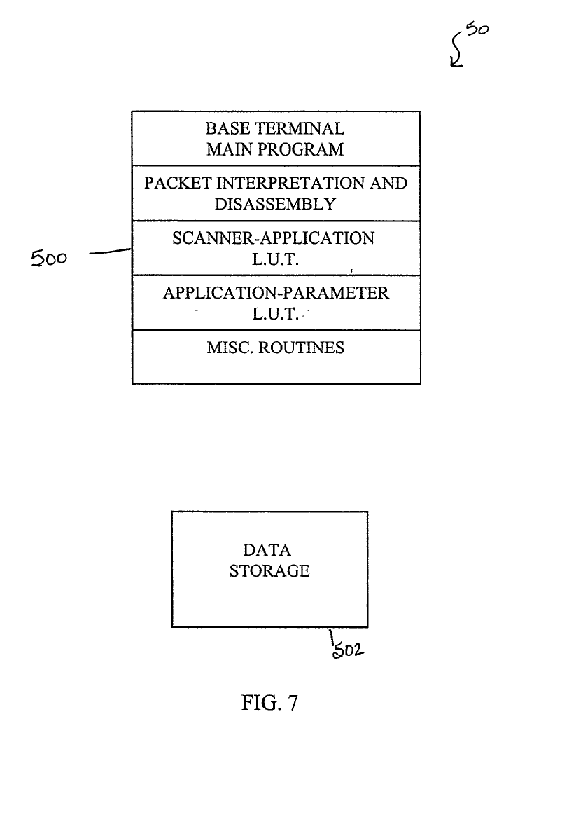

As embodied herein and depicted in FIG. 7, a diagram representing the memory map of base terminal 40 according to the present invention is shown. Memory 50 includes erasable programmable read only memory (EPROM) 500, which is used for storing the base terminal firmware. Memory 500 includes a base terminal main program, a packet interpretation and disassembly routine, a scanner-application look-up table, an application-parameter look-up table, and other miscellaneous routines that run on processor 48.

Memory 50 also includes data storage memory 502. Memory 502 may be of any suitable type, but there is shown by way of example a SRAM which is used by processor 48 for data storage.

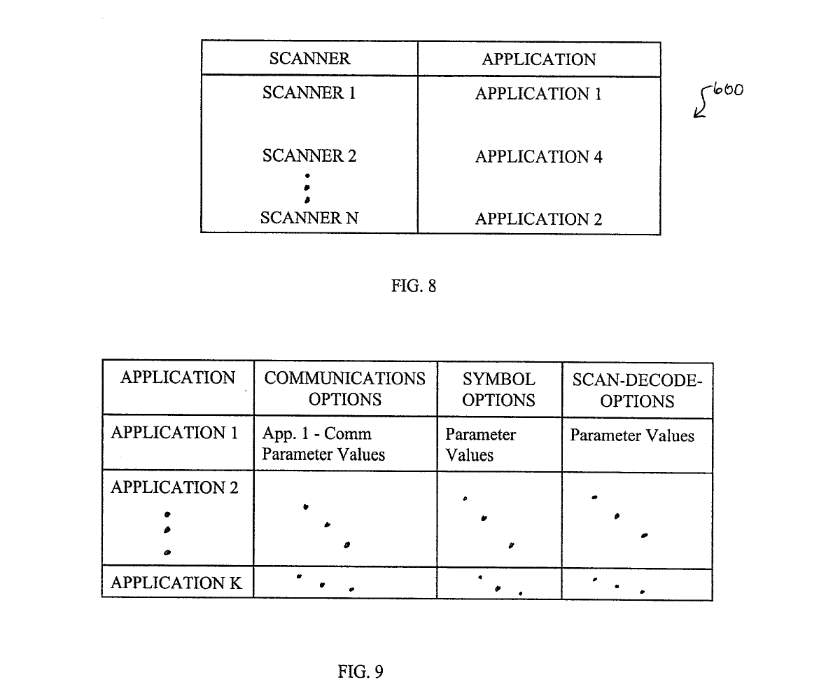

As embodied herein and depicted in FIG. 8, a diagram showing the structure of a scanner-application look-up table 600 disposed in memory 500 is shown. Network 10 may include N-optical scanners 20. Theoretically, there can be an infinite number applications. Look-up-table (LUT) 600 correlates each scanner 20 in network 10 with the current application of each scanner 20 using suitable addressing identifiers. LUT 600 can be stored in any memory structure in network 10, but it is preferably stored in base terminal memory 50.

FIG. 9 is a diagram showing the structure of an application-parameter look-up table 700 disposed in memory 500 of base terminal 40. Application parameter table 700 correlates each application with the parameters needed to control the various aspects of network operations. Further, application-parameter table 700 includes the plurality of parameters used to control symbology, scanning, decoding, and communications in optical scanners 20 for all of the applications supported by network 10.

As embodied herein and depicted in FIG. 10, an exemplary base terminal flow chart according to the present invention is depicted. In block 802, base terminal 40 reads the packet transmitted by scanner 20. Base terminal 40 determines in block 804 whether the packet contains an application selector symbol request, or decoded data. If the packet is an application selector packet, base terminal 40 retrieves the parameter table subset corresponding to the requested application from LUT 700 (FIG. 9), and changes the scanner-application LUT 600 accordingly. These actions are performed by blocks 806-808. If the packet is not an application selector packet, block 810 is performed and the remainder of the packet header is read. Thus, base terminal 40 identifies the scanner 20 from which the packet was sent, the current application being run on scanner 20, the message number, the number of packets in the message, and the number of the packet being evaluated. Using this information, the decoded data payload is stored in an appropriate place in data storage memory 502. In block 814, base terminal processor 48 determines whether all the packets in the message were received. If not, the processor waits for additional packets to be received. If all packets have been received, processor 48 assembles all of the decoded data payloads into a concatenated data string. Of course, the concatenated data string includes all of the data stored in the 2D optical symbol decoded by scanner 20. In block 818, base terminal 40 transmits the decoded data to host 100 via communications link 14.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A cordless optical scanner for reading an optically encoded symbol, the optical scanner converting the optically encoded symbol into decoded data, the optical scanner comprising:
a packet assembly component operative to convert the decoded data into at least one packet; and
a communications component coupled to the packet assembly component, the communications component being operative to transmit the at least one packet to a base terminal.

2. The cordless scanner of claim 1, wherein the at least one packet includes a header packet.

3. The cordless scanner of claim 2, wherein the header packet includes decoded data if a transmission to the base terminal includes only one packet.

4. The cordless scanner of claim 3, wherein the header portion includes at least an optical scanner identifier, a length of the decoded data, and error checking information.

5. The cordless scanner of claim 2, wherein the at least one packet includes a non-header packet.

6. The cordless scanner of claim 5, wherein the non-header packet includes a field identifying the type of optical symbol being read by the optical scanner.

7. The cordless scanner of claim 6, wherein the optically encoded symbol includes 2D symbols, stacked linear symbols, and matrix symbols.

8. The optical scanner of claim 1, further comprising:
a scan assembly operative to read the optical symbol, whereby the symbol is converted into an electrical signal; and
a decoding component coupled to the scan assembly and the packet assembly component, the decoding component converting the electrical signal into the decoded data.

9. The optical scanner of claim 8, wherein the scan assembly is a linear scan assembly.

10. The optical scanner of claim 8, wherein the scan assembly is an area scan assembly.

11. The optical scanner of claim 1, further comprising:
a scan assembly operative to read the optical symbol, whereby the optical symbol is converted into an electrical signal;
a processor coupled to the scan assembly, the processor being programmed to, decode the electrical signal to thereby produce decoded data,
assemble the decoded data into at least one packet;
a modulator coupled to the processor, the modulator being operative to modulate the plurality of packets using a transmission protocol; and
a transmitter coupled to the modulator, the transmitter being operative to transmit the modulated plurality of packets over at least one frequency.

12. The optical scanner of claim 1, wherein the optical symbol is a portable data file symbol.

13. The optical scanner of claim 12, wherein the portable data file symbol is a PDF 417 symbol.

14. The optical scanner of claim 12, wherein the portable data file symbol is a micro PDF symbol.

15. The optical scanner of claim 1, wherein the portable data file symbol is a Code One symbol.

16. The optical scanner of claim 1, wherein the portable data file symbol is a DataMatrix symbol.

17. The optical scanner of claim 1, wherein the portable data file symbol is a MaxiCode symbol.

18. The optical scanner of claim 1, wherein the communications component includes a radio device for modulating and transmitting the plurality of packets in accordance with a transmission protocol.

19. A data collection network comprising:
at least one cordless optical scanner, the optical scanner being operative to convert an optical symbol into at least one packet for transmission over an RF channel; and
a base terminal coupled to the at least one cordless optical scanner via the RF channel, the base terminal being operative to reassemble the at least one packet into decoded data.

20. The network of claim 19, wherein the at least one optical scanner includes a plurality of optical scanners.

21. The network of claim 20, wherein the base terminal includes a memory having an application parameter look-up table stored therein, the look-up table storing application parameters for each of the plurality of optical scanners, whereby the base terminal is configured to contemporaneously communicate with each of the plurality of optical scanners.

22. The network of claim 21, wherein application parameters include a type of optical symbol being decoded by each of the plurality of optical scanners.

23. The network of claim 22, wherein the type of optical symbol being decoded by the optical scanner is a portable data file symbol.

24. The optical scanner of claim 23, wherein the type of optical symbol being decoded by the optical scanner is a PDF 417 symbol.

25. The optical scanner of claim 23, wherein the type of optical symbol being decoded by the optical scanner is a micro PDF symbol.

26. The optical scanner of claim 22, wherein the type of optical symbol being decoded by the optical scanner is a Code One symbol.

27. The optical scanner of claim 22, wherein the type of optical symbol being decoded by the optical scanner is a DataMatrix symbol.

28. The optical scanner of claim 22, wherein the type of optical symbol being decoded by the optical scanner is a MaxiCode symbol.

29. The network of claim 21, wherein application parameters include transmission protocol data.

30. The network of claim 21, wherein application parameters include optical scanner scanning rate data.

31. The network of claim 21, wherein the base terminal further comprises:
a base communications component operative to receive the transmitted at least one packet from the at least one optical scanner; and
a base processor coupled to the base communications component, the base processor programmed to process the received at least one packet to thereby recover the decoded data; and
a first base memory coupled to the base processor, the first base memory being operative to store the decoded data.

32. The network of claim 31, wherein the base processor further comprises:
a packet interpreter component, the interpreter component operative to read at least one informational field of the packet, whereby the at least one packet is processed in accordance with information retrieved from the at least one informational field,
a packet disassembler portion coupled to the packet interpreter component, the packet disassembler being operative to recover the decoded data portion; and
a message assembler coupled to the packet disassembler, the message assembler being operative to assemble the decoded data portion of each packet to thereby produce the decoded data.

33. The network of claim 31, wherein the base communications component further comprises:
a transmitter component adapted to upload control data to the at least one optical scanner; and
a receiver component adapted to receive the at least one packet from the at least one optical scanner.

34. The network of claim 19, further comprising a host computer coupled to the base terminal, the host computer being adapted to further process the decoded data.

35. The network of claim 34, wherein the host computer is coupled to the base terminal by means of an RS-232 data link.

36. The network of claim 34, wherein the host computer is coupled to the base terminal by means of a wedge terminal.

37. The network of claim 34, wherein the host computer is coupled to the base terminal by means of a LAN.

38. The network of claim 34, wherein the host computer is coupled to the base terminal by means of a universal serial bus.

39. A method for transmitting information contained in an optical symbol using a wireless network, the wireless network including at least one cordless optical scanner and a base terminal, the method comprising:
reading the optical symbol with the cordless optical scanner to thereby generate decoded data;
assembling the decoded data into at least one packet;
transferring the plurality of packets from the cordless optical scanner to the base terminal over an RF channel; and
converting the at least one packet into the decoded data.

40. A computer readable medium having stored thereon a data structure, the data structure comprising:
a first field including an optical scanner identifier, the optical scanner identifier identifying an optical scanner;
a second field including an optical symbol identifier, the optical symbol identifier identifying a type of optical symbol being decoded by the optical scanner; and
a third field including error checking information, the error checking information enabling a receiving base station to check a received message for errors.

41. The computer readable medium of claim 40, wherein the data structure is a header packet adapted to a multiple packet transmission format.

42. The computer readable medium of claim 41, wherein the data structure is a non-header packet adapted to a multiple packet transmission format.

43. The computer readable medium of claim 40, wherein the data structure is a packet adapted to a single packet transmission format.

44. The computer readable medium of claim 40, wherein the data structure includes a fourth field for containing symbol data, the symbol data representing data contained in an optical symbol of the type identified by the optical symbol identifier.
